(19) United States
(12) Patent Application Publication
(10) Pub. No.: US 2017/0355218 A1
(43) Pub. Date: Dec. 14, 2017

(54) Glass Element For Shower Cubicle

(71) Applicant: PR Germany GmbH, Koeln (DE)

(72) Inventors: Martin Frielingsdorf, Werkhausen (DE); Karl Labuhn, KoeIn (DE)

(21) Appl. No.: 15/621,703

(22) Filed: Jun. 13, 2017

(30) Foreign Application Priority Data
Jun. 13, 2016 (CN) 201610412660.X

(51) Int. Cl. B44C 5/04; E04F 13/08; E05D 5/02; E04H 1/12; A47K 3/28

(52) U.S. Cl. CPC B44C 5/04; E04F 13/08; E05D 5/0246; A47K 3/28; E04H 1/12

(57) ABSTRACT

The present invention relates to a glass element (1), which has at least one first plate (2) formed of glass, at least one second plate (3) and at least one sandwich layer (8), wherein the sandwich layer (8) is disposed between the first plate (2) and the second plate (3). The first plate (2) has a first side (4) and a second side (5), wherein the first side (4) is disposed on the sandwich layer (8). An adaptor unit (15) formed of metal is bonded to the first side (4) of the first plate (2). The adaptor unit (15) has a fixing unit (18). The fixing unit is disposed on a through-hole (14) of the second plate (3).

### TECHNICAL FIELD

The present invention relates to a glass element, in particular for a shower cubicle.

### BACKGROUND ART

A shower cubicle is known from the prior art, and has at least one defining wall formed of glass. For example, the defining wall is formed completely of glass. The defining wall is for example fixed to a room wall by means of corner pieces formed of metal. In addition, a known shower cubicle has a door formed of glass, for enabling entry into the shower cubicle. The door is for example formed completely of glass. The door formed of glass is for example disposed on a room wall by means of a joint strip or for example on another defining wall also formed of glass.

The joint strip used here has a first strip piece and a second strip piece. In addition, the joint strip has a joint shaft element, wherein the first strip piece and the second strip piece are connected to each other in a hinged manner around the joint shaft element. Such a joint strip is known from EP 822309 B1. Such a known joint strip has a first strip piece and a second strip piece, which are connected to each other in a hinged manner around a joint shaft element which takes the form of a shaft pin. A locking means having a locking body and a locking recess is located in the joint strip. The locking body is movably guided in the first strip piece against the action of a spring. The locking recess is disposed in the second strip piece. In a locked state, the locking body is elastically inserted in the locking recess. The locking recess is positioned on a guiding body, which guiding body is supported so as to be rotatable around a shaft pin and is fixed relative to the second strip piece by means of a clamping means.

Cleaning of the defining wall made of glass is for example carried out by using a scraper, the scraper having a scraping unit formed of plastic, for example an elastomer. The scraping unit is placed on the defining wall and moves on the defining wall, and can thus remove condensation and/or water droplets from the defining wall.

It is specified for the known shower cubicle that fixing units are used to dispose the corner pieces (used to fix the defining wall) and/or the joint strip (used to connect the defining wall to another room wall in a hinged manner) on the defining wall. However, the fixing units protrude slightly from the flat surface of the defining wall. Thus, the flat surface of the defining wall and the fixing units are unable to form a uniform flat surface. When the defining wall is cleaned by using a scraper to scrape the defining wall, it is very easy to knock the scraper into the fixing units. It thus becomes very difficult to clean the defining wall quickly and adequately by scraping. It is therefore desirable for the flat surface of the defining wall (which is cleaned using a scraper) to have no protrusions, so that scraping of the defining wall can be achieved very simply.

### Content of the Invention

The technical problem to be solved by the present invention is providing a glass element, which enables a glass defining wall to be cleaned simply by scraping the defining wall.

This technical problem is solved according to the present invention by means of a glass element, which has at least one first plate formed of glass, at least one second plate and at least one sandwich layer, wherein the sandwich layer is disposed between the first plate and the second plate, wherein the first plate has a first side and a second side, wherein the first side is disposed on the sandwich layer; an adaptor unit formed of metal is bonded to the first side of the first plate by means of a glass/metal adhesive which can be hardened; the adaptor unit has a fixing unit; and wherein the fixing unit is disposed on a through-hole of the second plate. Other features of the present invention are obtained from the attached description, the attached claims and/or the accompanying drawings.

The glass element according to the present invention has a first plate formed of glass. In addition, the glass element according to the present invention has at least one second plate. A sandwich layer is disposed between the first plate and the second plate. Thus, it is specified for the glass element according to the present invention that the first plate is disposed on the sandwich layer, and that the sandwich layer in turn is disposed on the second plate.

In addition, it is also specified for the glass element according to the present invention that the first plate has a first side and a second side. In particular it is specified that the second side is opposite the first side. The first side of the first plate is disposed on the sandwich layer. Thus the first side is designed as an inner side of the first plate. Conversely, the second side of the first plate is designed as an outer side of the first plate.

The glass element according to the present invention also has a metal adaptor unit. In particular it may be specified that the adaptor unit is formed of metal either completely or partially. For example, stainless steel is suitable for serving as the metal, but the present invention is not limited to this; on the contrary, various metals or a combination of various metals suitable for the present invention could be used. It is specified here that the adaptor unit is bonded to the first side of the first plate by means of a glass/metal adhesive which can be hardened. In other words, the adaptor unit is fixed to the first side of the first plate by bonding achieved by means of a glass/metal adhesive which can be hardened.

The adaptor unit according to the present invention has at least one fixing unit disposed on a through-hole of the second plate. In particular it is specified that the fixing unit can be touched by a user through the through-hole in the second plate, in order to fit another unit to the glass element.

The glass element according to the present invention is for example designed as a door, a glass wall and/or a window. The glass element according to the present invention is for example designed as a door of a shower cubicle. It must be clearly pointed out that the present invention is not limited to the abovementioned applications. On the contrary, the glass element according to the present invention may be used for various service purposes.

The advantage of the glass element according to the present invention is that the fixing unit will not protrude from the first plate and/or the second plate. It is thus always feasible that at least one of the two plates (i.e. the first plate and/or the second plate) always has, on one side thereof, a plate surface designed to be flat. Thus, it can be very simple to scrape, using a scraper, the side(s) in order to clean and dry the side(s).

It is additionally or alternatively specified in an embodiment of the glass element according to the present invention that the fixing unit is designed as a screw-thread element. However, the present invention is not limited to this embodiment. Conversely, various forms of fixing device (suitable for the present invention) may be provided as fixing units.

It is additionally or alternatively specified in another embodiment of the glass element according to the present invention that a holding unit is disposed on the fixing unit. The holding unit is for example arranged on a holding corner piece. The holding unit for example forms a part of the holding corner piece. The holding corner piece is for example used for fixing the glass element to a wall, for example a room wall or a defining wall, wherein the defining wall is for example also formed of glass.

It is additionally or alternatively specified in another embodiment of the glass element according to the present invention that the holding unit is disposed on a joint strip, wherein the joint strip has a first strip piece and a second strip piece. The first strip piece and the second strip piece are connected together in a hinged manner around a joint shaft. The joint shaft may be disposed on the first strip piece and on the second strip piece. In particular it is specified here that the holding unit is designed as the first strip piece. This embodiment for example specifies that the glass element is designed as a door, in particular a door for a shower cubicle formed of glass.

It is additionally or alternatively specified in another embodiment of the glass element according to the present invention that the holding unit has a bolt element, the bolt element being disposed on the fixing unit. The holding unit also has a cover unit which covers the bolt element. It is feasible for the holding unit to be fixed to the fixing unit by means of the bolt element. To avoid impairing the esthetic effect, a cover unit is provided, which covers the bolt element. Thus, the bolt element is invisible to an observer.

It is additionally or alternatively specified in another embodiment of the glass element according to the present invention that the second strip piece has a pressure element. The pressure element is for example accommodated in a hole of the second strip piece, and is designed to be movable towards the joint shaft. The pressure element is designed to be movable, such that it can abut the joint shaft. In other words, the pressure element is in contact with the joint shaft. When the pressure element abuts the joint shaft, a clamping force is produced. Thus, the position of the second strip piece relative to the joint shaft is fixed. In this embodiment, it is thus possible for the position of the joint shaft relative to the second strip piece to be adjusted. Thus, a closed position of the glass element designed as a door may for example be adjusted such that the glass element, for example by means of a force, abuts a sealing means so fully that water will not flow out of an interior space of the shower cubicle.

It is additionally or alternatively specified in an embodiment of the glass element according to the present invention that the second strip piece has at least one fixing means for fixing the second strip piece to a wall element. The fixing means is for example designed as a bolt connection. The second strip piece is fixed to the wall element by means of the bolt connection.

It is additionally or alternatively specified in another embodiment of the glass element according to the present invention that the glass/metal adhesive is an acrylate-based adhesive which can be hardened by means of light (i.e. which is optically hardenable). The glass/metal adhesive is for example hardened by means of ultraviolet light. In addition, it is for example specified that the glass/metal adhesive has a heat resistance of at most 120° C. It is specified in another embodiment that the glass/metal adhesive may also have a tolerance of at most 150° C. for a short time.

It is additionally or alternatively specified in an embodiment of the glass element according to the present invention that the first plate, the second plate and/or the sandwich layer is/are designed to be transparent.

It is in particular specified for the glass element according to the present invention that the sandwich layer is formed of polyvinyl butyral (PVB). In addition, it is additionally or alternatively specified in another embodiment of the glass element according to the present invention that the sandwich layer has at least one first layer and at least one second layer. Another embodiment specifies that at least three layers are used, i.e. a first layer, a second layer and a third layer.

It is additionally or alternatively specified in another embodiment of the glass element according to the present invention that the second plate is formed of glass and/or plastic. Thus, the second plate need not be formed of glass. Thus the second plate could also be formed of plastic, for example organic glass.

The present invention also relates to a shower cubicle having at least one glass element, the glass element having at least one of the features described above or below, or a combination of at least two other features described above or below.

### DESCRIPTION OF THE ACCOMPANYING DRAWINGS

The present invention is explained further below with reference to embodiments. In the drawings:

FIG. 1 shows a sectional view of a glass element having an adaptor unit; and

FIG. 2 shows a sectional view of the glass element according to FIG. 1, disposed on a joint strip.

### PARTICULAR EMBODIMENTS

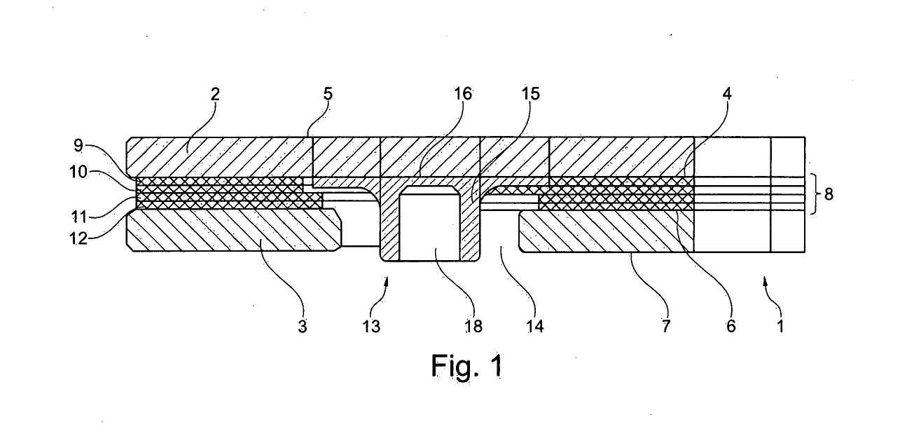

FIG. 1 shows a sectional view of a glass element 1 according to the present invention. The glass element 1 is for example designed as a door, a glass wall and/or a window. The glass element 1 according to the present invention is designed as a door of a shower cubicle. It must be clearly pointed out that the present invention is not limited to this application. On the contrary, the glass element according to the present invention may be used for various service application purposes.

The glass element 1 has a first plate 2, formed of glass. The first plate 2 has a first side 4 and a second side 5. The first side 4 and the second side 5 are arranged opposite one another. In addition, the glass element 1 according to the present invention has a second plate 3, which is provided with a first side 6 and a second side 7. The first side 6 of the second plate 3 and the second side 7 of the second plate 3 are arranged opposite one another. The first plate 2 and the second plate 3 are formed of single-plate safety glass (ESG) of thickness 4 mm. It must be pointed out that the present invention is not limited to this embodiment. On the contrary, various glass thicknesses suitable for the present invention may be used in the present invention. In addition, the second plate 3 need not necessarily be formed of glass. On the contrary, the second plate 3 could also be formed of plastic, in particular organic glass.

A sandwich layer 8 is disposed between the first plate 2 and the second plate 3. Here, the sandwich layer 8 is disposed in this way on the first plate 2 and the second plate 3, so that the gap between the first plate 2 and the second plate 3 is substantially filled completely.

The first side 4 of the first plate 2 is substantially an inner side of the first plate 2. Conversely, the second side 5 of the first plate 2 forms an outer side of the first plate 2. A roughly similar arrangement is suitable for the second plate 3. Here, the first side 6 of the second plate 3 is substantially an inner side of the second plate 3. Conversely, the second side 7 of the second plate 3 forms an outer side of the second plate 3.

The sandwich layer 8 is disposed both on the first side 4 of the first plate 2, and on the first side 6 of the second plate 3. The sandwich layer 8 has four separate layers in the embodiment shown. Thus, the sandwich layer 8 comprises a first layer 9, a second layer 10, a third layer 11 and a fourth layer 12. These layers are all formed of polyvinyl butyral (PVB). In addition, it is specified in this embodiment of the glass element 1 that the first plate 2, the second plate 3 and the sandwich layer 8 are each formed of a transparent material.

The glass element 1 according to the present invention has a partial region 13 in which the sandwich layer 8 is interrupted. A through-hole 14 of the second plate 3 is disposed in the partial region 13. In addition, in the partial region 13, a metal adaptor unit 15 is bonded to the first side 4 of the first plate 2 by means of an (acrylate-based) adhesive 16. The adhesive 16 can be hardened by light, e.g. by ultraviolet light. In order to arrange the first plate 2, the sandwich layer 8, the second plate 3 and the adaptor unit 15 so as to be fixed with respect to each other, it is specified for example that the units are connected to each other by heat treatment. Such heat treatment is for example disclosed in DE 102007017971; the content thereof is entirely cited here in the present application. The glass element 1 is thus designed as a composite element.

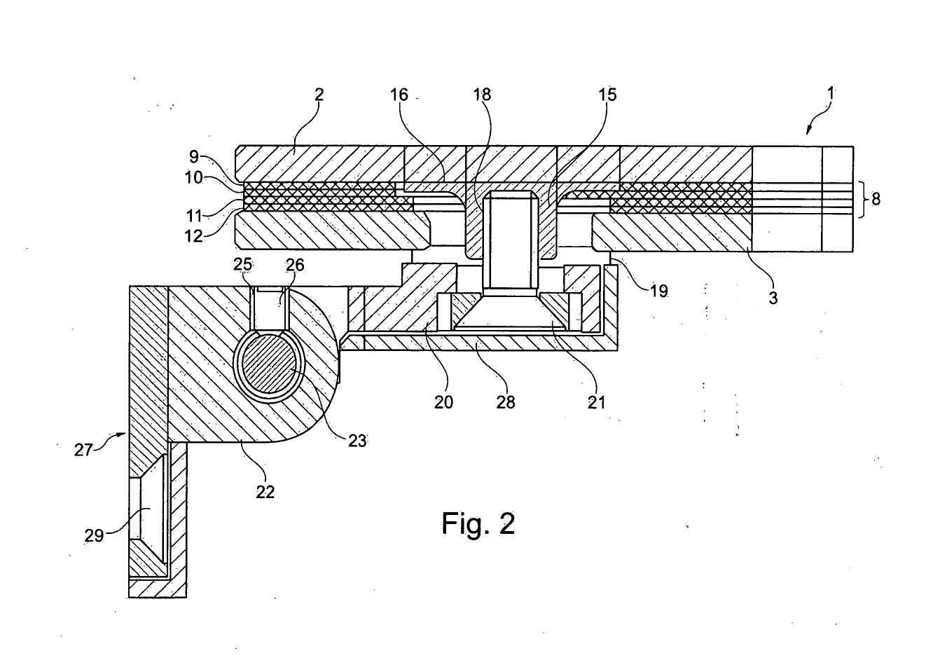

FIG. 2 shows another sectional view of a glass element according to the present invention. The embodiment according to FIG. 2 is based on the embodiment according to FIG. 1. Identical drawing labels relate to identical members. A joint strip 27 is shown in the embodiment of FIG. 2, by way of addition to the embodiment of FIG. 1. By means of the joint strip 27, the glass element 1 designed for example as a shower cubicle door is turned from a first position (e.g. a closed position) into a second position (e.g. an open position). The joint strip 27 has a first strip piece 20 and a second strip piece 22, which are connected to each other in a hinged manner around a joint shaft 23. The joint shaft 23 is disposed on both the first strip piece 20 and on the second strip piece 22.

The first strip piece 20 is designed as a holding unit. The holding unit is used for fixing the joint strip 27 to the adaptor unit 15. To this end, the first strip piece 20 is fixed to the adaptor unit 15 by means of a bolt element 21 (which is inserted in an internal screw-thread 18 of the adaptor unit 15) and is thereby fixed to the glass element 1. To avoid damaging the second plate 3, a washer 19 is disposed between the first strip piece 20 and the second plate 3, wherein the washer is formed of plastic for example.

To avoid impairing the esthetic effect, a cover unit 28 is provided; this is disposed on the first strip piece 20 and covers the bolt element 21. Thus, the bolt element 21 is invisible to an observer.

The second strip piece 22 has a fixing means 29, which is at least used for fixing the second strip piece 22 to a wall element. The fixing means 29 is for example designed as a bolt connection. The second strip piece is fixed by means of the bolt connection to the wall element, which is for example a room wall or another glass wall of the shower cubicle.

The second strip piece 22 has a pressure element 26, which is designed as a countersunk bolt. The pressure element 26 is disposed in an accommodating part 25 of the second strip piece 22. The accommodating part 25 has an internal screw-thread, into which a thread of the pressure element 26 designed as a countersunk bolt is inserted. The pressure element 26 is disposed in the accommodating part 25 in such a way as to be movable towards the joint shaft 23. Here, the pressure element 26 is formed to be movable in such a way that it is able to abut the joint shaft 23. In other words, when abutting the joint shaft 23, the pressure element 26 is in contact with the joint shaft 23. When the pressure element 26 is in abutment, the pressure element 26 applies such a large force to the joint shaft 23 that the position of the second strip piece 22 relative to the joint shaft 23 is fixed. Thus, in this embodiment, it is possible that the position of the joint shaft 23 relative to the second strip piece 22 can be adjusted. Thus, it is for example possible that a closed position of the glass element 1 designed as a door may be adjusted such that the glass element 1, by means of said force, abuts a sealing means so fully that no water will flow out of an interior space of the shower cubicle.

The advantage of the glass element 1 according to the present invention is that a fixing unit in the form of an internal screw-thread 18 will not protrude from the first plate 2. Thus, it is always possible that the second side 5 of the first plate 2 always has a plate surface, formed in a planar fashion. The second side 5 of the first plate 2 is a side which faces a wet space of the shower cubicle. The second side 5 can thus be scraped simply by means of a scraper, in order to clean and dry said side.

All inventive features disclosed in the present description, accompanying drawings and claims can realize various embodiments of the present invention, either separately or in any combination. The present invention is not limited to said embodiments. Said embodiments can be changed within the scope of the claims, taking into account directions from those skilled in the art.

### LIST OF DRAWING LABELS

1 glass element
2 first plate
3 second plate
4 first side of first plate
5 second side of first plate
6 first side of second plate
7 second side of second plate
8 sandwich layer
9 first layer
10 second layer
11 third layer
12 fourth layer
13 partial region of glass element
14 through-hole of second plate
15 metal adaptor unit
16 adhesive
18 internal screw-thread
19 washer
20 first strip piece
21 bolt element
22 second strip piece
23 joint shaft
25 accommodating part
26 pressure element
27 joint strip
28 cover unit
29 fixing means

1. A glass element (1), having
at least one first plate (2) formed of glass,
at least one second plate (3) and
at least one sandwich layer (8), wherein the sandwich layer (8) is disposed between the first plate (2) and the second plate (3), wherein
the first plate (2) has a first side (4) and a second side (5), wherein the first side (4) is disposed on the sandwich layer (8);
an adaptor unit (15) formed of metal is bonded to the first side (4) of the first plate (2) by means of a glass/metal adhesive (16) which can be hardened;
the adaptor unit (15) has a fixing unit (18); and wherein
the fixing unit (18) is disposed on a through-hole (14) of the second plate (3).

2. The glass element (1) as claimed in claim 1, wherein the fixing unit (18) is a screw-thread element.

3. The glass element (1) as claimed in claim 1, wherein
a holding unit is disposed on the fixing unit, and wherein
the holding unit is disposed on a holding corner piece.

4. The glass element (1) as claimed in claim 1, wherein:
a holding unit (20) is disposed on the fixing unit (18), and wherein
the holding unit (20) is disposed on a joint strip (27), wherein the joint strip (27) has a first strip piece (20) and a second strip piece (22), wherein the first strip piece (20) and the second strip piece (22) are connected together in a hinged manner around a joint shaft (23), wherein the joint shaft (23) is disposed both on the first strip piece (20) and on the second strip piece (22), and wherein the holding unit (20) is the first strip piece.

5. The glass element (1) as claimed in claim 4, wherein:
the holding unit (20) has a bolt element (21), the bolt element being disposed on the fixing unit (18), and wherein
the holding unit (20) has a cover unit (28) which covers the bolt element (21).

6. The glass element (1) as claimed in claim 4, wherein:
a pressure element (26) is disposed on the second strip piece (22),
the pressure element (26) is movable towards the joint shaft, and wherein
the pressure element (26), when abutting the joint shaft (23), fixes the position of the second strip piece (22) relative to the joint shaft (23).

7. The glass element (1) as claimed in one of claim 4, wherein the second strip piece (22) has at least one fixing means (29) for fixing the second strip piece (22) to a wall element.

8. The glass element (1) as claimed in claim 1, wherein the glass/metal adhesive (16) is an acrylate-based adhesive which can be hardened by means of light.

9. The glass element (1) as claimed in claim 1, wherein the first plate, the second plate or the sandwich layer is transparent.

10. The glass element (1) as claimed in claim 1, wherein the sandwich layer is formed of polyvinyl butyral (PVB).

11. The glass element (1) as claimed in claim 1, wherein the sandwich layer (8) has at least one first layer (9, 10, 11, 12) and at least one second layer (9, 10, 11, 12).

12. The glass element (1) as claimed in claim 1, wherein the second plate (3) is formed of glass or plastic.

13. A shower cubicle, having at least one glass element (1), the glass element (1) having:
at least one first plate (2) formed of glass,
at least one second plate (3) and
at least one sandwich layer (8), wherein the sandwich layer (8) is disposed between the first plate (2) and the second plate (3), wherein
the first plate (2) has a first side (4) and a second side (5), wherein the first side (4) is disposed on the sandwich layer (8);
an adaptor unit (15) formed of metal is bonded to the first side (4) of the first plate (2) by means of a glass/metal adhesive (16) which can be hardened;
the adaptor unit (15) has a fixing unit (18); and wherein
the fixing unit (18) is disposed on a through-hole (14) of the second plate (3).

14. The glass element (1) as claimed in claim 13, wherein
a holding unit is disposed on the fixing unit (18), and wherein
the holding unit is disposed on a joint strip (27), wherein the joint strip (27) has a first strip piece (20) and a second strip piece (22), wherein the first strip piece (20) and the second strip piece (22) are connected together in a hinged manner around a joint shaft (23), wherein the joint shaft (23) is disposed both on the first strip piece (20) and on the second strip piece (22), and wherein the holding unit (20) is the first strip piece.

15. The glass element (1) as claimed in claim 14, wherein
the holding unit (20) has a bolt element (21), the bolt element being disposed on the fixing unit (18), and wherein
the holding unit (20) has a cover unit (28) which covers the bolt element (21).

16. The glass element (1) as claimed in claim 14, wherein
a pressure element (26) is disposed on the second strip piece (22),
the pressure element (26) is movable towards the joint shaft, and wherein
the pressure element (26), when abutting the joint shaft (23), fixes the position of the second strip piece (22) relative to the joint shaft (23).

17. The glass element (1) as claimed in claim 2, wherein
a holding unit is disposed on the fixing unit, and wherein
the holding unit is disposed on a holding corner piece.

18. The glass element (1) as claimed in claim 2, wherein
a holding unit is disposed on the fixing unit (18), and wherein
the holding unit is disposed on a joint strip (27), wherein the joint strip (27) has a first strip piece (20) and a second strip piece (22), wherein the first strip piece (20) and the second strip piece (22) are connected together in a hinged manner around a joint shaft (23), wherein the joint shaft (23) is disposed both on the first strip piece (20) and on the second strip piece (22), and wherein the holding unit (20) is the first strip piece.

19. The glass element (1) as claimed in claim 5, wherein
a pressure element (26) is disposed on the second strip piece (22),
the pressure element (26) is movable towards the joint shaft, and wherein
the pressure element (26), when abutting the joint shaft (23), fixes the position of the second strip piece (22) relative to the joint shaft (23).

20. The glass element (1) as claimed in one of claim 6, wherein the second strip piece (22) has at least one fixing means (29) for fixing the second strip piece (22) to a wall element.
